(19) United States
(12) Patent Application Publication
(10) Pub. No.: US 2009/0309982 A1
(43) Pub. Date: Dec. 17, 2009

(54) Method and System for Image Stabilization

(76) Inventors: Jarkko Rouvinen, Espoo (FI); Petteri Kauhanen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/085,817

(22) PCT Filed: Jan. 27, 2006
(86) PCT No.: PCT/IB2006/000153

§ 371 Date: Sep. 1, 2009

Related U.S. Application Data
(60) Provisional application No. 60/741,233, filed on Nov. 30, 2005.

(51) Int. Cl. H04N 5/228

(52) U.S. Cl. 348/208.2; 348/E05.046

(57) ABSTRACT

An optical image stabilizer for use in a camera to compensate for an unwanted movement of camera, wherein two bending actuators are used to shift a lens element or the image sensor in different directions in a plane so as to shift a projected image on the image sensor in response to the unwanted camera movement. The plane is substantially perpendicular to the optical axis of camera, and longitudinal axis of each bending actuator is substantially parallel to the optical axis. The actuator can be fixedly mounted on one end so that the other end is allowed to bend. The actuator can be fixedly mounted on both ends so that the middle section is allowed to bend. Alternatively, the middle section is fixedly mounted and both ends can be used for shifting an imaging component.

### FIELD OF THE INVENTION

The present invention relates generally to a camera and, more particularly, to the stabilization of an image during the exposure time of the camera.

### BACKGROUND OF THE INVENTION

The problem of image stabilization dates back to the beginning of photography, and the problem is related to the fact that an image sensor needs a sufficient exposure time to form a reasonably good image. Any motion of the camera during the exposure time causes a shift of the image projected on the image sensor, resulting in a degradation of the formed image. The motion related degradation is called motion blur. Using one or both hands to hold a camera while taking picture, it is almost impossible to avoid an unwanted camera motion during a reasonably long exposure time. Motion blur is particularly easy to occur when the camera is set at a high zoom ratio when even a small motion could significantly degrades the quality of the acquired image.

Optical image stabilization generally involves laterally shifting the image projected on the image sensor in compensation for the camera motion. Shifting of the image can be achieved by one of the following four general techniques:

Lens shift—this optical image stabilization method involves moving one or more lens elements of the optical system in a direction substantially perpendicular to the optical axis of the system;

Image sensor shift—this optical image stabilization method involves moving the image sensor in a direction substantially perpendicular to the optical axis of the optical system;

Liquid prism—this method involves changing a layer of liquid sealed between two parallel plates into a wedge in order to change the optical axis of the system by refraction; and

Camera module tilt—this method keeps all the components in the optical system unchanged while tilting the entire module so as to shift the optical axis in relation to a scene.

In any one of the above-mentioned image stabilization techniques, an actuator mechanism is required to effect the change in the optical axis or the shift of the image sensor. Actuator mechanisms are generally complex, which means that they are expensive and large in size.

The present invention provides a new method and device for shifting one or more lens elements or the image sensor in an XY-plane, wherein the actuators are arranged differently from the above-described method.

### SUMMARY OF THE INVENTION

The present invention uses an optical image stabilizer to compensate for an unwanted movement of an imaging system, such as a camera. Two separate bending actuators are used to shift a lens element or the image sensor in different directions in a plane so as to shift a projected image on the image sensor based on the movement of the imaging system. The plane is substantially perpendicular to the optical axis of the imaging system, and longitudinal axis of each bending actuator is substantially parallel to the plane. In one embodiment of the present invention, one end of each bending actuator is fixedly disposed on the image system and the other end is used to shift the lens element or the image sensor. In another embodiment of the present invention, both ends of each bending actuator are fixed, while the middle section is allowed to move for shifting the lens element or the image sensor.

Thus, the present invention provides a method and system for optical image stabilization for use in an imaging system having a plurality of imaging components arranged in relationship to an optical axis, the imaging components comprising an image sensor and at least a lens element for projecting an image on the image sensor, wherein the projected image can be shifted relative to the image sensor in a direction substantially perpendicular to the optical axis. The imaging system comprises:

a first bending actuator operatively connected to at least one of the imaging components for moving the imaging component in a first direction, the first bending actuator having a length defining a first actuator axis;

a second bending actuator operatively connecting said at least one imaging component for moving the imaging component in a second direction, the second bending actuator having a length defining a second actuator axis, wherein the image plane and each of the first and second actuator axes form an angle smaller than 45 degrees. a driving system, in response to the movement of the imaging system, for causing at least part of the first actuator to move in a direction different from the first actuator axis so as to shift said at least one imaging component in a plane substantially perpendicular to the optical axis, and for causing at least part of the second actuator to move in a direction different from the second actuator axis so as to shift said at least one imaging component in a plane substantially perpendicular to the optical axis. The imaging component can be a lens component or the image sensor.

Each of the bending actuator can be mounted on the imaging system in a number of ways. The actuator can be fixedly mounted on one of its ends so as to allow the other end to bend. The actuator can be fixedly mounted on both ends so as to allow the middle section to move. Alternatively, the actuator can be fixedly mounted on a middle section so that one or both ends can be used to move an imaging component.

The present invention will become apparent upon reading the description taken in conjunction with FIGS. 3 to 16.

### BRIEF DESCRIPTION OF THE DRAWINGS

FIG. 1 shows the relationship between the XY-plane and the optical axis of an imaging system.

FIG. 2 shows an on-axis actuator disposed parallel to the Y-axis.

FIG. 3 shows a bending or off-axis actuator.

FIG. 4a shows a bending actuator for shifting a carrier along the X-axis, according to the present invention.

FIG. 4b shows a bending actuator for shifting a carrier along the Y-axis, according to the present invention.

FIG. 5 is a schematic representation of an imaging system, according to one embodiment of the present invention.

FIG. 6 shows a carrier having two bending actuators for shifting the lens element in an image system.

FIGS. 7a to 7c show the carrier being shifted to the upper left, center and lower right position.

FIG. 8 shows a schematic representation of an imaging system, according to another embodiment of the present invention.

FIG. 9 shows another carrier for mounting the image sensor, according to the present invention.

FIGS. 10a and 10b show a carrier with a different amount arrangement.

FIG. 11 shows a different bending actuator.

FIG. 12 shows a lens carrier having two bending actuators, according to a different embodiment of the present invention.

FIG. 13 shows a different lens carrier design, according to the present invention.

FIG. 14 shows a typical driving system for driving a bending actuator.

FIG. 15 shows a variation in the placement of a bending actuator in reference to the optical axis of imaging system.

FIG. 16 shows a typical image stabilizer system.

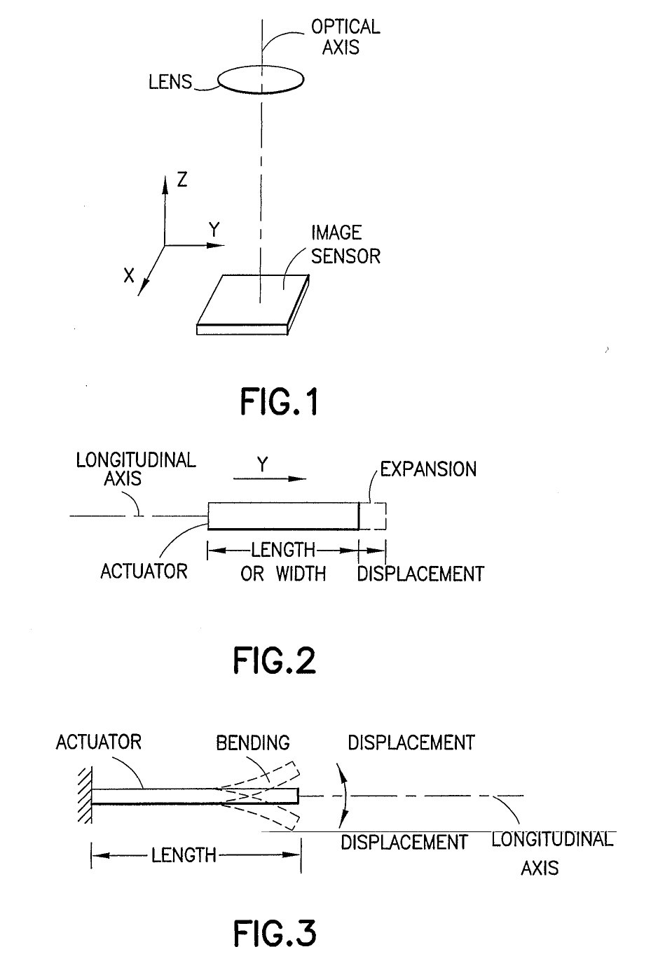

### DETAILED DESCRIPTION OF THE INVENTION

In an imaging system having an image sensor and a lens to project an image on the image sensor, the present invention uses one or more bending actuators to shift the image projected on the image sensor for image stabilization purposes. The actuators can be used to shift the lens or the image sensor or both in one or more directions substantially parallel to the image plane. The actuators are mechanically engaged with a carrier carrying the imaging component to be shifted.

When an on-axis actuator is activated, it contracts or expands in a direction that shortens or lengthens the thickness or the length of the actuator. For example, if the actuator is a long piece of piezoelectric material having a longitudinal axis along its length, then the displacement of the actuator when activated is also along the longitudinal axis, as shown in FIG. 2. In a bending actuator, as shown in FIG. 3, the displacement of the actuator is not along its length or longitudinal axis. Instead, the displacement is off-axis and approximately equal to the length times the bending angle.

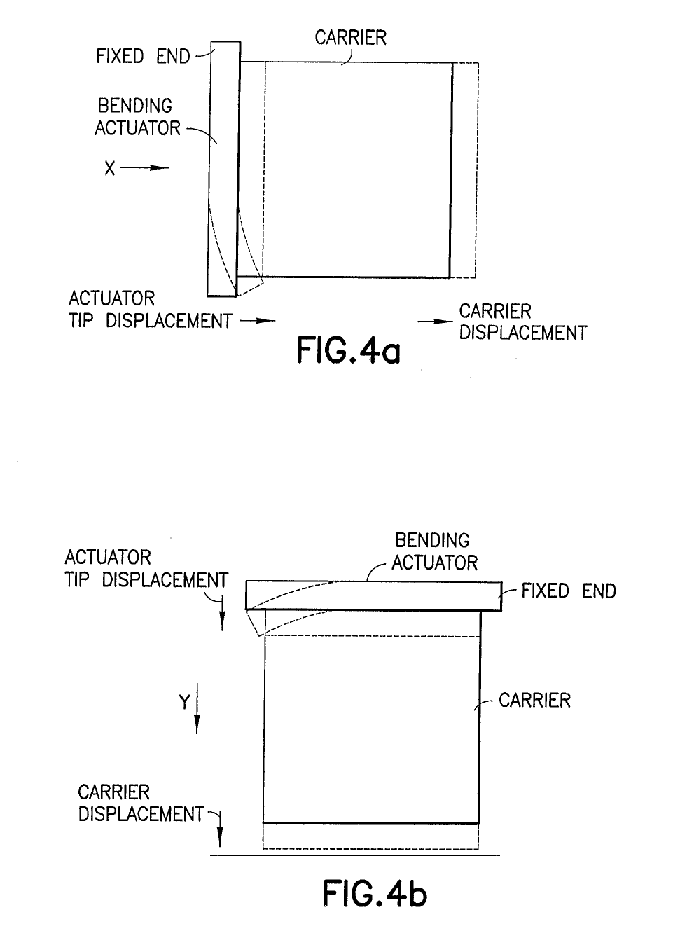

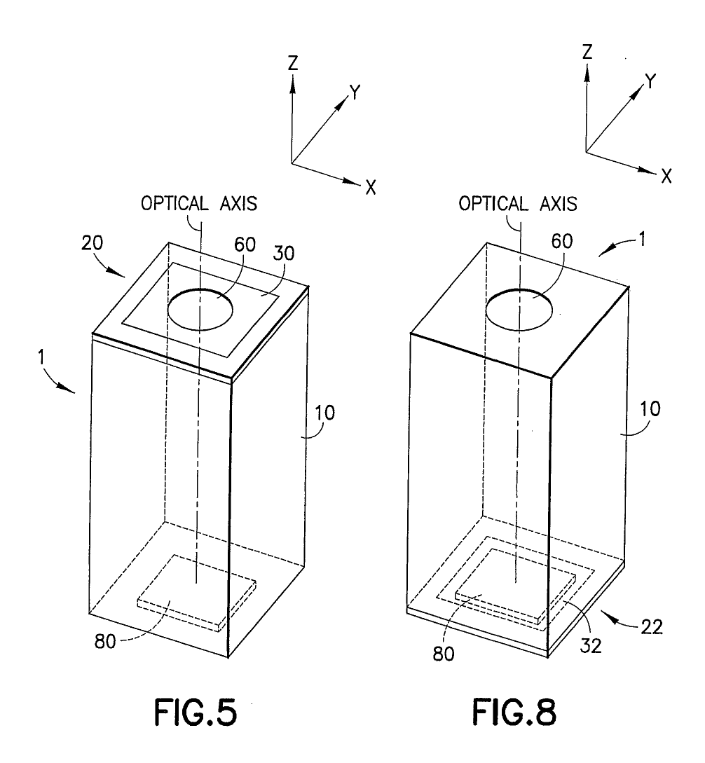

When it is used to move a lens element or the image sensor in a camera, a bending actuator can be disposed such that the longitudinal axis of the actuator is perpendicular to the shifting direction of an imaging component of the imaging system but substantially parallel to the plane in which the imaging component is shifted. FIGS. 4a and 4b show the principle of using a bending actuator to move a carrier in the X-direction and in the Y-direction, with the optical axis being parallel to the Z-axis.

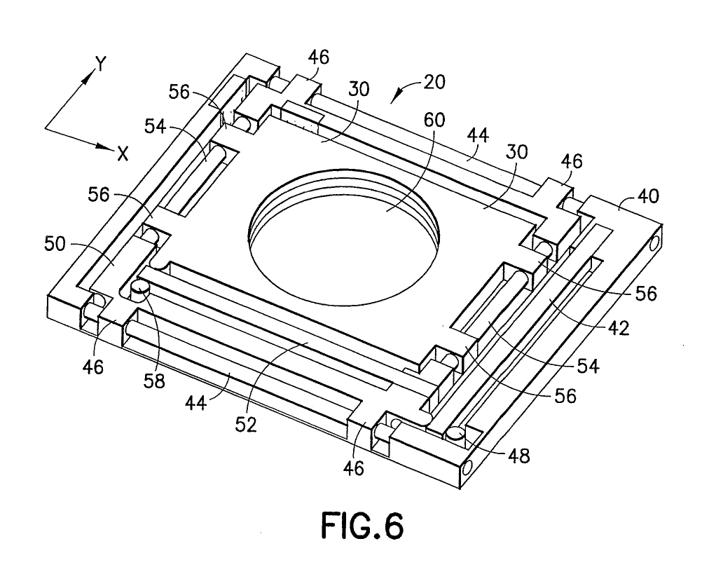

According to one of the embodiments of the present invention, the lens is fixedly mounted on the carrier to be moved by a pair of bending actuators, as shown in FIGS. 5 and 6. As shown, the imaging system 1, according to the present invention, comprises a device body 10 for mounting an image sensor 80 and a lens 60 for projecting an image on the image sensor along the optical axis of the imaging system. The lens 60 is fixedly mounted on a carrier 30. The carrier can be moved in the X-direction by a first bending actuator 42 and in the Y-direction by a second bending actuator 52. The first bending actuator 42 is mounted on an outer support frame 40 of a lens plate 20, and the second bending actuator 52 is mounted on an inner support frame 50. As shown in FIG. 6, the inner support frame 50 has two pairs of brackets 46 and each pair is mounted on a guide pin 44 so as to allow the inner support frame to move along the X-direction by a sliding motion. Likewise, the carrier 30 has two pairs of brackets 56 and each pair is mounted on a guide pin 54 so as to allow the carrier 30 to move along the Y-direction by a sliding motion. As shown, one end of the first bending actuator 42 is fixedly mounted on the outer support frame 40, and the other end is allowed to move sidewise when activated. The movable end of the first bending actuator 42 is urged by a spring 48 to move inward. When the first bending actuator 42 moves sidewise, it pushes the inner support frame 50 in the X-direction. Likewise, one end of the second bending actuator 52 is fixedly mounted on the inner support frame 50, and the other end is allowed to move sidewise when activated. The movable end of the second bending actuator 52 is urged by a spring 58 to move inward. When the second bending actuator 52 moves sidewise, it pushes the carrier 30 in the Y-direction.

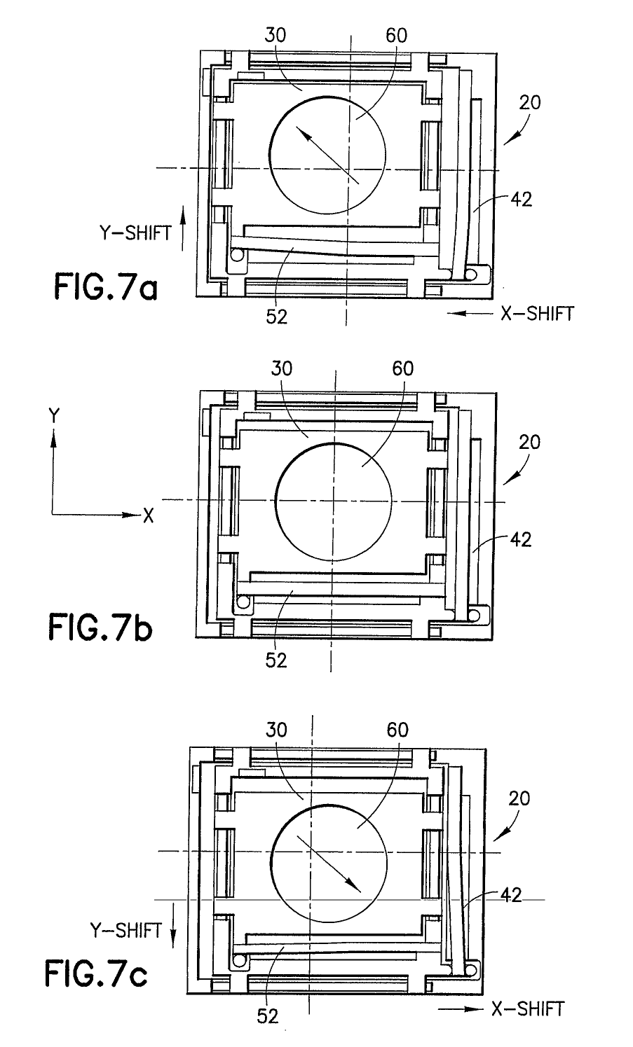

The shifting of the lens 60 in the various directions is depicted in FIGS. 7a to 7c. FIG. 7a shows the lens 60 being shifted to the upper left corner of the lens plate 20. FIG. 7b shows the lens 60 being positioned in the center, and FIG. 7c shows the lens 60 being shifted to the lower right corner of the lens plate 20.

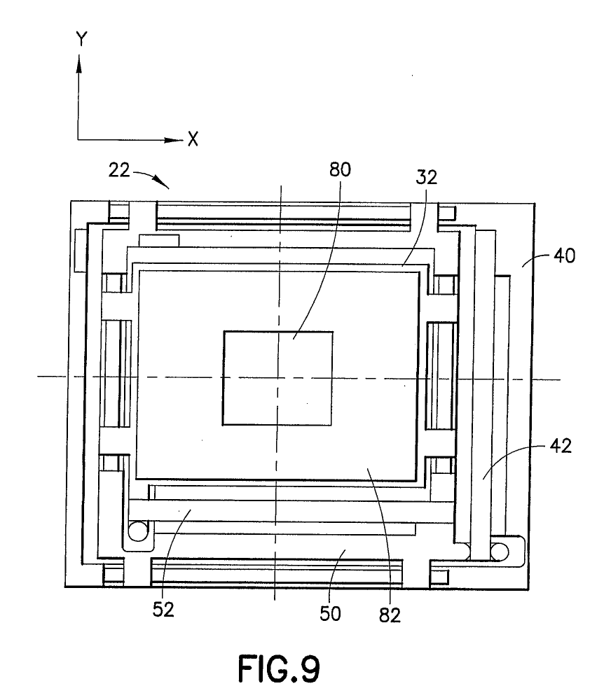

The actuator arrangement as shown in FIG. 6 can also be used to shift the image sensor 80. As shown in FIGS. 8 and 9, the imaging system 1, according to another embodiment of the present invention, comprises a sensor plate 22 for mounting the image sensor 80. The image sensor 80 and its circuit board 82 are fixedly mounted on a carrier 32. The carrier 32 can be moved in the X direction by a first bending actuator 42 and in the Y direction by a second bending actuator 52. The mechanical structure of the sensor plate 22 is basically the same as that of the lens plate 20. Thus, when the first bending actuator 42 moves sidewise, it pushes the inner support frame 50 along with the image sensor 80 in the X-direction. When the second bending actuator 52 moves sidewise, it pushes the carrier 32 along with the image sensor 80 in the Y-direction.

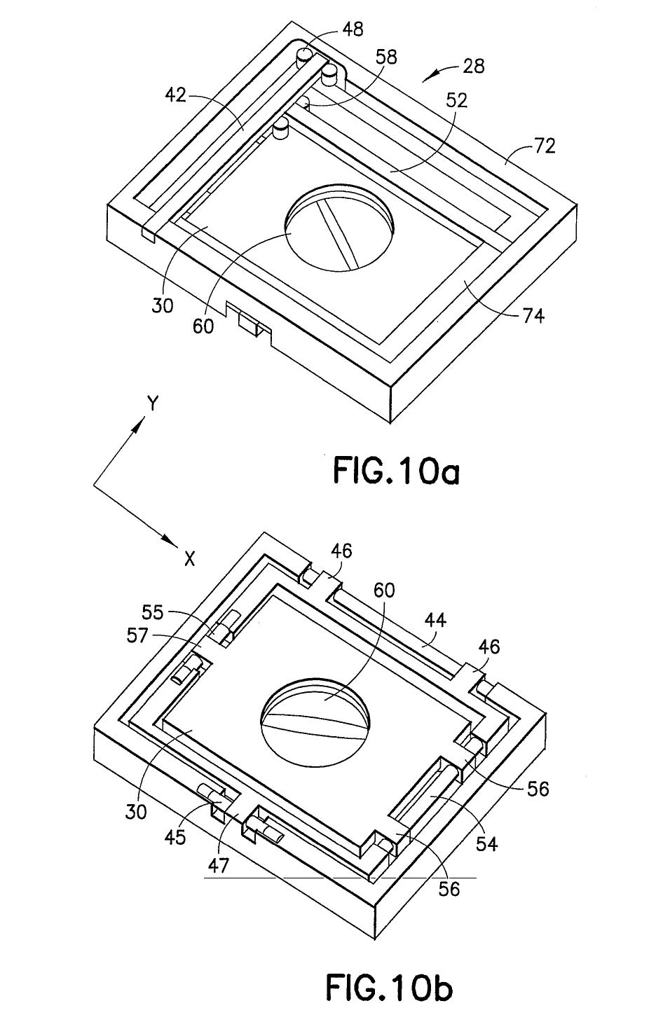

The lens plate and the carrier plate can be constructed differently. As shown in FIGS. 10a and 10 b, the lens plate 28 is constructed as having two layers stacked within an outer frame 72, for example. FIG. 10a shows one side of the frame 72. As shown, the first bending actuator 42 and the spring 48 are mounted on the outer frame 72, and the second bending actuator 52 and the spring 58 are mounted on an inner frame 74. The lens 60 is fixedly mounted on the lens carrier 30. FIG. 10b shows the other side of the outer frame 72. As shown, the outer frame 72 has a first guiding pin 44 and a second guiding pin 45 for movably mounting the inner frame 74 via a pair of brackets 46 and a single bracket 47. Likewise, the inner frame 74 has a first guiding pin 54 and a second guiding pin 55 for moving mounting the lens carrier 30. Such construction can reduce the footprint of the imaging system.

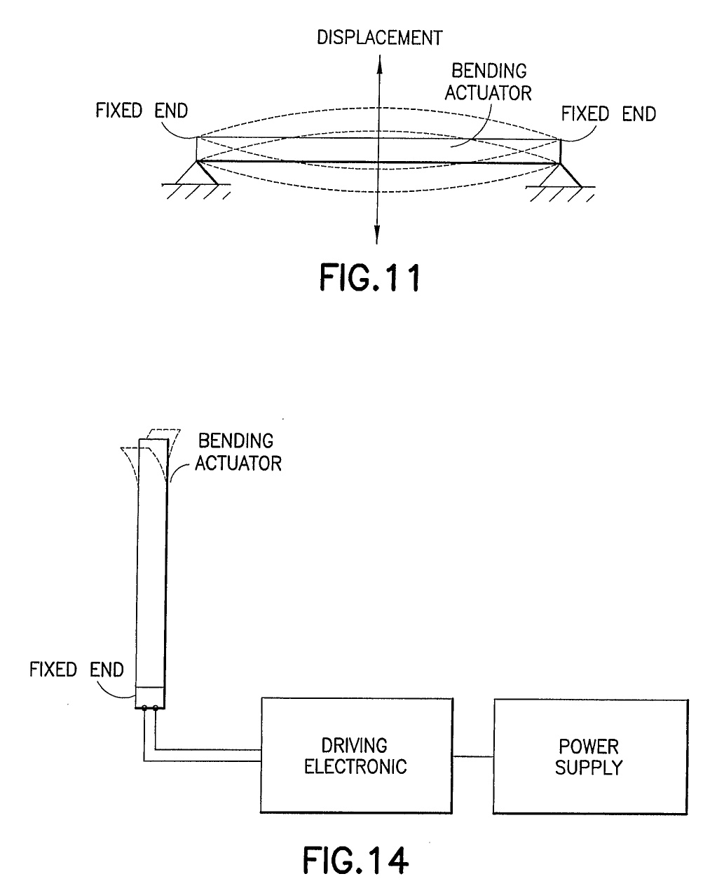

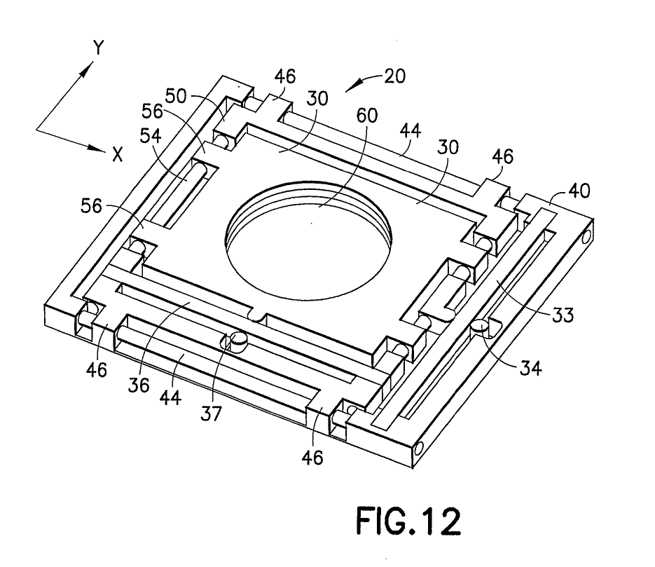

Furthermore, the bending actuators can be used in a different setting. As shown in FIG. 11, both ends of the actuator are fixedly mounted to the stationary part of the imaging system. When the activator is activated, the middle section of the actuator undergoes a bending motion to move a carrier. For example, both ends of an actuator 33 are fixedly mounted to the outer frame 40, and both ends of another actuator 36 are fixedly mounted to the inner frame 50, as shown in FIG. 12. When the actuator 33 is activated, it is able to move to inner frame 50 along with the lens 60 in the X-direction. Likewise, when the actuator 36 is activated, it is able to move the lens carrier 30 along with the lens 60 in the Y-direction for image stabilization purposes. On the lens plate 20 as shown in FIG. 12, a spring 34 is used to urge the actuator 33 to move inward along the X-direction, and a spring 37 is used to urge the actuator 36 to move inward along the Y-direction. In a different embodiment, one or more sections between the ends are fixedly mounted so as to allow both ends to bend and to use one or both of the ends for moving the lens plate or the carrier.

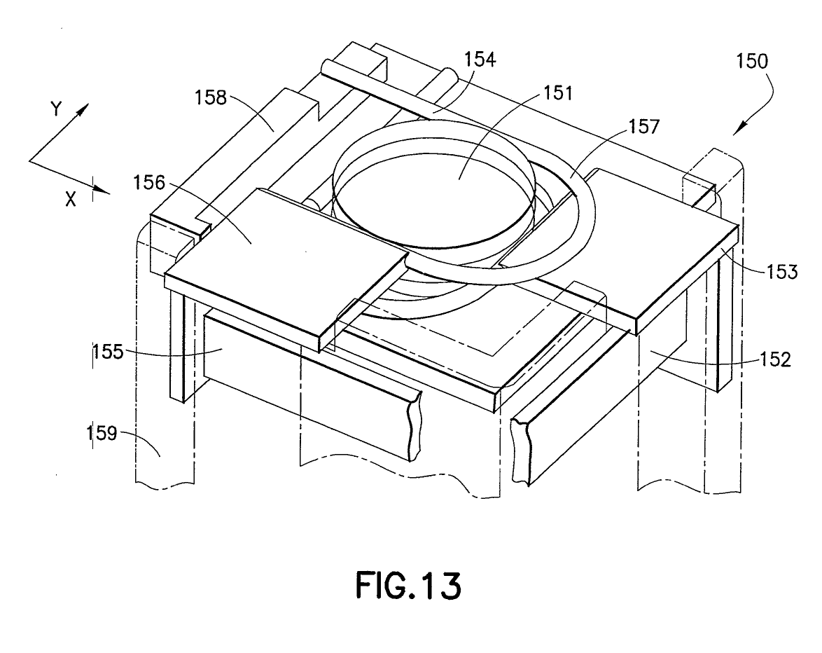

Moreover, the lens carrier can be designed differently as shown in FIG. 13. As shown in FIG. 13, the lens carrier 150 comprises a correction framework 158 for mounting an actuator 152 for the X-direction movement via a bracket 153, and for mounting another actuator 155 for the Y-direction movement via a bracket 156. A U-shaped hook 157 is fixedly attached to the bracket 156 and another U-shaped hook 154 is fixedly attached to the bracket 153 to move the lens element 51. The position of the lens element 51 is determined substantially by the parallel sections of each of the hooks 154, 157. For example, when the actuator 155 moves in the Y-direction in response to activation, the lens element is guided by the U-shaped hook 157 to move along the Y-direction.

It should be noted that the bending actuator, according to the present invention, can be a piezoelectric monomorph actuator, a piezoelectric bimorph actuator, a piezoelectric multi-layer actuator, an ion conductive polymer actuator or the like. Furthermore, it is known in the art that an actuator needs a driving system for activating the actuator. FIG. 14 is a typical driving system. As shown, one end of the actuator is operatively connected to a driving electronic module, which is connected to a camera movement sensor/signal processor so that the actuator moves the imaging component in response to the camera movement. Preferably, when only one end of the bending actuator is fixedly mounted on a carrier or on a frame, as shown in FIGS. 6, 10a and 10b, the fixed end is operatively connected to the driving electronic module. But when both ends of the bending actuator are fixedly mounted to a carrier or a frame, as shown in FIG. 12, either end of the bending actuator can be connected to the driving electronic module.

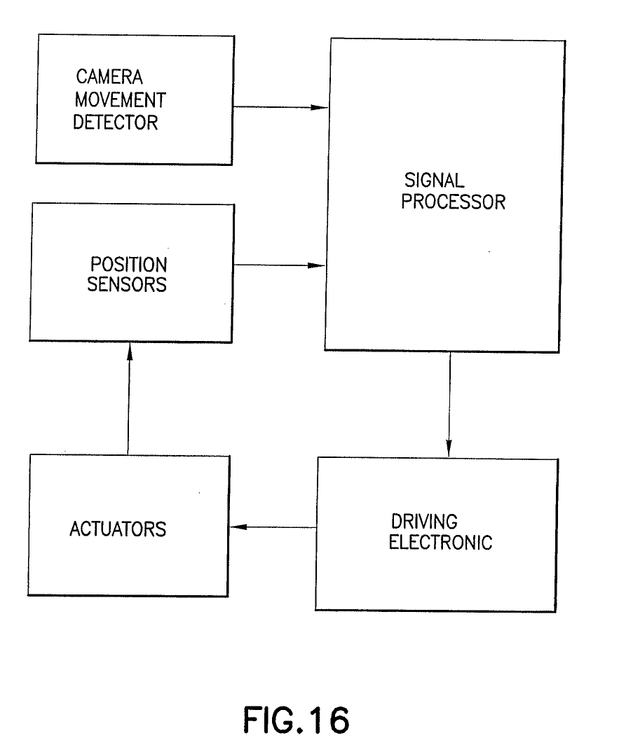

Furthermore, when one or more of the imaging components are shifted for image stabilization purposes, other components are also needed. For example, the image stabilizer for the imaging system also has a movement detector to determine the movement to be compensated for, at least one position sensors to determine the current position of the imaging components, a signal processor to compute the shifting amount in different directions for compensating for the camera movement based on the positions of the components and the camera movement, and an actuator control to activate the actuators in order to shift the image components by a desired amount. A block diagram illustrating such an image stabilizer is shown in FIG. 16. The movement detector may include a gyroscope, accelerometer or other known movement detector, for example.

The lens of the imaging system may comprise two or more lens elements and the actuators may be used to move one or more lens elements.

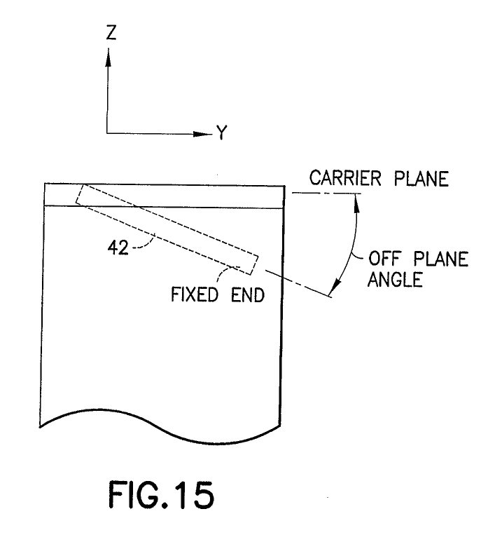

It should be noted that, in FIGS. 6, 9, and 10b, the bending actuator is depicted as being placed in a carrier that is substantially parallel to the XY plane. However, it is also possible to place the bending actuator differently. As shown in FIG. 15, the bending actuator 42 is placed off the XY-plane with the fixed end spaced from the carrier. The off-plane angle between the actuator 42 and the XY-plane is, in practice, should not be greater than 45 degrees.

It should be understood for a person skilled in the art that the lens plate 20 as depicted in FIG. 6, the carrier plate 22 as depicted in FIG. 9, and the lens plate 28 as depicted in FIG. 10a are for illustration purposes only. The present invention in which two bending actuators are used to shift an imaging component, such as a lens element and an image sensor, can also be achieved with a different plate design or arrangement. Furthermore, any of the lens plates 20, 28 and the carrier plate 22 can be used to shift other imaging components for optical image stabilization purposes. For example, one of the plates can be used to shift two optical wedges or thin prisms separately in the X-direction and the Y-direction.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. An apparatus comprising:
an apparatus body;
a plurality of imaging components arranged in the apparatus body in relationship to an optical axis, the imaging components comprising an image sensor disposed in an image plane and at least a lens element for projecting an image on the image sensor, wherein the projected image is shiftable relative to the image plane in a direction substantially perpendicular to the optical axis in response to a movement of the apparatus;
a bending actuator operatively connected to at least one of the imaging components, the bending actuator having a length defining an actuator axis; and by
a driving module, in response to the movement of the apparatus system, for causing at least part of the actuator to move in a direction different from the actuator axis so as to shift said at least one imaging component in a plane substantially perpendicular to the optical axis.

2. The apparatus of claim 1, wherein the shift of said at least one imaging component is in a first direction in the plane, said imaging further comprising:
a further bending actuator operatively connecting said at least one imaging component, the further bending actuator having a length defining a further actuator axis, wherein the further bending actuator is operatively connected to the driving system so that the further actuator can be caused to move in a further direction different from the further actuator axis so as to shift said at least one imaging component in the plane in a second direction different from the first direction.

3. The apparatus of claim 1, wherein said one imaging component comprises the lens element.

4. The apparatus of claim 1, wherein said one imaging component comprises the image sensor.

5. The apparatus of claim 1, further comprising a frame for mounting said at least one of the imaging components, wherein said actuator has a first end and an opposing second end defining the length and wherein the first end is fixedly mounted on the frame relative to the optical axis and the second end is operatively connected to said at least one imaging component so that the second end of the actuator is moveable in the direction different from the actuator axis.

6. The apparatus of claim 1, wherein the second end of the actuator is spaced from the plane.

7. The apparatus of claim 1, wherein the actuator axis is substantially perpendicular to the optical axis.

8. The apparatus of claim 2, wherein the further actuator axis is substantially perpendicular to the optical axis.

9. The apparatus of claim 1, further comprising a frame for mounting said at least one of the imaging components wherein said actuator has a first end, an opposing second end and a middle section between the first and second ends, and wherein both the first and second end are fixedly mounted on the frame relative to the optical axis and the middle section is operatively connected to said at least one imaging component so that the middle section of the actuator is moveable in the direction different from the actuator axis.

10. The apparatus of claim 9, wherein said at least one imaging component comprises the lens element.

11. The apparatus of claim 1, further comprising a frame for mounting said at least one of the imaging components, wherein said actuator has a first end, an opposing second end and a middle section between the first and second ends, and wherein the middle section is fixedly mounted on the frame relative to the optical axis and both the first and second end are operatively connected to said at least one imaging component so that both the first and second end of the actuator are moveable in the direction different from the actuator axis.

12. The apparatus of claim 2, further comprising:
a movement sensing module for detecting the movement of the apparatus.

13. The apparatus of claim 12, wherein that the movement sensing module comprises one or more gyroscope sensors.

14. The apparatus of claim 12, wherein the movement sensing module comprises one or more accelerometers.

15. The apparatus of claim 12, further comprising:
at least one position sensing module for determining the current position of the imaging component to be shifted by the bending actuator.

16. The apparatus of claim 15, further comprising:
a processor, operatively connected to the movement sensing module and the position sensing module, for determining a shifting amount of the projected image in order to compensate for the movement of the apparatus, said processor further connected to the driving module to cause the actuator and the further actuator to move.

17. The apparatus of claim 1, wherein the actuator axis and the image plane form an angle smaller than 45 degrees.

18. A method for use in an imaging apparatus, said method comprising:
operatively connecting at least one of a plurality of imaging components in the imaging apparatus to a bending actuator having a length defining an actuator axis, wherein the imaging components arranged in relationship to an optical axis, the imaging components comprising at least an image sensor and a lens element for projecting an image on the image sensor, and wherein the projected image is shiftable in an image plane in a direction substantially perpendicular to the optical axis and
causing at least part of the actuator to move in a direction different from the actuator axis so as to shift said at least one imaging component in a plane substantially perpendicular to the optical axis.

19. The method of claim 18, wherein the shift of said at least one imaging component is in a first direction in the plane, said method further comprising:
operatively connecting said at least one imaging component to a further bending actuator having a length defining a further actuator axis; and
causing at least part of the further actuator to move in a further direction different from the further actuator axis so as to shift said at least one imaging component in the plane in a second direction different from the first direction.

20. The method of claim 18, wherein said one imaging component comprises the lens element.

21. The method of claim 18, wherein said one imaging component comprises the image sensor.

22. The method of claim 18, wherein the imaging apparatus comprises a frame for mounting said at least one of the imaging components and wherein said actuator has a first end and an opposing second end defining the length, said method further comprising:
fixedly mounting the first end on the frame relative to the optical axis and operatively connecting the second end to said at least one imaging component so that the second end of the actuator is moveable in the direction different from the actuator axis.

23. The method of claim 18, wherein the imaging apparatus comprises a frame for mounting said at least one of the imaging components and wherein said actuator has a first end, an opposing second end and a middle section between the first and second ends, said method further comprising:
fixedly mounting both the first and second end on the frame relative to the optical axis and operatively connecting the middle section to said at least one imaging component so that the middle section of the actuator is moveable in the direction different from the actuator axis.

24. The method of claim 18, wherein the imaging apparatus comprises a frame for mounting said at least one of the imaging components and wherein said actuator has a first end, an opposing second end and a middle section between the first and second ends, said method further comprising:
fixedly mounting the middle section on the frame relative to the optical axis and operatively connecting the first and second ends to said at least one imaging component so that both the first and the second ends of the actuator are moveable in the direction different from the actuator axis.

25. An image stabilizer module for an imaging apparatus, said image stabilizer module comprising:
a first bending actuator operatively connected to at least one of a plurality of imaging components in the imaging apparatus, the imaging components comprising an image sensor and at least a lens element for projecting an image on the image sensor wherein the projected image is shiftable relative to the image sensor in a direction substantially perpendicular to an optical axis, wherein the first bending actuator having a length defining a first actuator axis, and wherein at least part of the first actuator is dimensioned to move in a direction different from the first actuator axis so as to shift said at least one imaging component in a first direction in the plane based on the movement of the imaging apparatus, and
a second bending actuator operatively connected to said at least one imaging component, the second bending actuator having a length defining a second actuator axis, wherein at least part of the second actuator is dimensioned to move in a direction different from the second actuator axis so as to shift said at least one imaging component in a second direction in the plane also based on the movement of the imaging apparatus.

26. The image stabilizer module of claim 25, wherein said one imaging component comprises the lens element.

27. The image stabilizer module of claim 25, wherein said one imaging component comprises the image sensor.

28. The image stabilizer module of claim 25, wherein the imaging apparatus comprises a first frame for mounting said at least one of the imaging components, and a second frame for moveably mounting the first frame, and wherein said first actuator has a first end and an opposing second end defining the length of said first actuator, wherein the first end is fixedly mounted on the first frame relative to the optical axis and the second end is operatively connected to said at least one imaging component so that the second end of the first actuator is moveable in the direction different from the first actuator axis, and
said second actuator has a first end and an opposing second end defining the length of said second actuator, wherein the first end is fixedly mounted on the second frame relative to the optical axis and the second end is operatively connected to said at least one imaging component so that the second end of the second actuator is moveable in the direction different from the second actuator axis.

29. The image stabilizer module of claim 25, wherein the first actuator axis is substantially perpendicular to the optical axis and the second actuator axis is substantially perpendicular to the optical axis.

30. The image stabilizer module of claim 25, wherein the imaging apparatus comprises a first frame for mounting said at least one of the imaging components and a second frame for moveably mounting the first frame, and wherein said first actuator has a first end, an opposing second end and a middle section between the first and second ends, wherein both the first and second end are fixedly mounted on the first frame relative to the optical axis and the middle section is operatively connected to said at least one imaging component so that the middle section of the first actuator is moveable in the direction different from the first actuator axis, and
said second actuator has a first end, an opposing second end and a middle section between the first and second ends, wherein both the first and second end are fixedly mounted on the second frame relative to the optical axis and the middle section is operatively connected to said at least one imaging component so that the middle section of the second actuator is moveable in the direction different from the second actuator axis.

31. The image stabilizer module of claim 25, wherein the imaging apparatus comprises a first frame for mounting said at least one of the imaging components and a second frame for moveably mounting the first frame, and wherein said first actuator has a first end, an opposing second end and a middle section between the first and second ends, wherein the middle section is fixedly mounted on the first frame relative to the optical axis and both the first and second end are operatively connected to said at least one imaging component so that both the first and second end of the first actuator are moveable in the direction different from the first actuator axis, and
said second actuator has a first end, an opposing second end and a middle section between the first and second ends, wherein the middle section is fixedly mounted on the second frame relative to the optical axis and both the first and second end are operatively connected to said at least one imaging component so that both the first and second end of the second actuator are moveable in the direction different from the second actuator axis.
